(19) United States
(12) Patent Application Publication
(10) Pub. No.: US 2007/0077048 A1
(43) Pub. Date: Apr. 5, 2007

(54) Automatic focusing method

(75) Inventors: Chieh-Cheng Liao, Taoyuan Hsien (TW); Yao-Min Lin, Taoyuan Hsien (TW)

Correspondence Address: BIRCH STEWART KOLASCH & BIRCH, PO BOX 747, FALLS CHURCH, VA, 22040-0747, US

(73) Assignee: Chroma Ate Inc.

(21) Appl. No.: 11/378,485

(22) Filed: Mar. 20, 2006

(30) Foreign Application Priority Data
Oct. 3, 2005 (TW) 094134500

(51) Int. Cl. G02B 7/04; G03B 17/00; G02B 27/40

(52) U.S. Cl. 396/79; 250/201.2; 396/81

(57) ABSTRACT

An automatic focusing method is provided, which is realized through an imaging device as based on the multi-stage search principle and a focusing function. Thus the focusing position search is implemented in three stages of: the optimal focusing position gross search, the wave packet interval search, and the optimal focusing position minute search, with the respective stages having different search-step-magnitudes. Wherein, the integer times of one half the wavelength of the incident light of the imaging device is utilized as the search-step-magnitude to search for the maximum value of the focusing function in the wave packet interval, and define the focusing position corresponding to the maximum value of the focusing function as the optimal focusing position, hereby obtaining the optimal focusing position in a speedy and efficient manner.

### BACKGROUND OF THE INVENTION

1. Field of the Invention

The present invention relates to an automatic focusing method for imaging devices, and in particular to a focus determination and adjustment method used in an imaging device to achieve the automatic focusing of the object to be measured, of which an image is to be taken.

2. The Prior Arts

In the conventional imaging system, the automatic focusing is utilized to adjust the focal length of a set of optical lenses thus to get a clear and accurate image. Usually, in the implementation of this technology, the curve of the focusing function for an imaging system is a single peak curve which changes its value along the focusing axis of a set of optical lenses, so that the maximum value of the function corresponds to the optimal focusing position defined by the system. However, for the interferometer, the curve of its focusing function is represented by the superimposition of the single peak curve of an imaging system and an interferogram curve of an interferometer. Since the correct focusing of the interferometer is essential to the quality of the interference fringes produced, thus indirectly affecting the accuracy of the measurement system, thus the focus position of the imaging system must first be adjusted properly before the measurement can be implemented. As mentioned earlier, the curve of the focusing function of the interferometer is not a simple curve having the maximum value at its single peak, it is rather provided with the wave-packet like undulations, so that it would be very time consuming if its focusing is done manually. In terms of accuracy, in case that the manual adjustment of the focus position is based on the judgment of a naked eye, then quite often the optimal focusing position is not easy to find and define. In terms of reproducibility, the manual determination and adjustment of the optimal focusing position is not liable to have consistent results. Thus, compared with manual focusing, the automatic focusing evidently may save a lot of time, enhance the accuracy and stability of the optical focusing process, and is indeed indispensable for the application of the interferometer in the industry.

In the application of the conventional interferometer automatic focusing method, the object lenses are moved back and forth at varied speed in the vicinity of the wave packet area to find and determine the boundary of the wave packet area, then the point of maximum intensity is set as the optimal focusing point. However, the major drawback of this conventional method of automatic focusing is that, even if the position to be searched is already in the wave packet area, it is still required to search back-and-forth to find and define the boundary of the wave packet area, so this kind of automatic focusing is pretty time consuming, besides, its search is restricted to the surrounding of the wave packet area, thus the search area is rather limited. In addition, in the application of this technology, a preset intensity is used as a threshold value to determine the optimal focusing point, yet this preset intensity may vary depending on the surface property of the object to be measured. Or, the position of maximum light intensity does not coincide with the position of zero light path difference due to the existence of aberration of the object lens of the interferometer, so that the optimal focusing point can not be found by making use of this method.

Moreover, some of the conventional technologies require the use of additional hardware to achieve the objective of automatic focusing, thus additional hardware arrangement must be provided to the interferometer, or the focusing operation may be performed only when sufficient information of wave packet area is provided, thus the search process is rather time consuming and is not suitable for large area automatic focusing.

Therefore, in view of the shortcomings and drawbacks of the automatic focusing method of the prior art, the research and development of a more advanced and improved automatic focusing method and its application, which is capable of providing a simple, speedy and accurate automatic focusing for the interferometer is the most urgent and important task in this field.

### SUMMARY OF THE INVENTION

In order to overcome the shortcomings and drawbacks of the prior art, the present invention provides a simple, speedy and highly accurate automatic focusing method for use in an interferometer, so that the results of focusing process will not be affected by the undulation of the curve of the focusing function, hereby achieving the objective of obtaining the optimal focusing position, effectively reducing the time required for the measurement preparation of the interferometer, and eliminating the possibility of manual focusing errors.

An another objective of the present invention is to provide an automatic focusing method, that can be used to perform 3-D measurement by making use of the white light interference technology, so as to scan the entire wave-packet area and accurately achieve the optimal focusing and effective scan range, while reducing the undesirable noise to the minimum and raising the measurement efficiency. As such, realizing the setting of the optical focal point as the center of scanning range, so that the measurement errors are reduced and the measuring data can be more accurate and convincing.

To achieve the above-mentioned objective of the present invention, the present invention provides an automatic focusing method and an application thereof, which can be realized by an interferometer, that may be an optical imaging system capable of fetching images and providing light source for generating interference signals, including: a light source, a set of object lenses, a light splitter, an imaging device, and a logic-arithmetic-control unit. In the application of the automatic focusing method of the invention, an incident light beam emitted from a light source is reflected to a set of object lenses through a light splitter, and reaches the object to be measured and is reflected to form the reflected light beam containing interference signals. This reflected light beam passes through the set of object lenses and is received by an imaging device after penetrating through a light splitter. In the above-mentioned structure, the logic-arithmetic-control unit is provided with a control means, which is used to adjust the focus position of the set of object lenses and record the optical information received by the imaging device. The essence of the automatic focusing method of the present invention lies in making calculation of the optical information fetched by the imaging device, thus obtaining the optimal focal length by means of the logic-arithmetic means of the logic-arithmetic-control unit. As such, the automatic focusing method of the present invention is realized through the following three stages of focusing: the optimal focusing position gross search, the wave packet interval search, and the optimal focusing position minute search. Wherein, in the respective stages, the focusing position search is performed in steps of different magnitudes, with the wavelength of light emitted by the light source as a basis for selecting the search-step-magnitude.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The related drawings in connection with the detailed description of the present invention to be made later are described briefly as follows, in which:

FIG. 1 is a flowchart of the steps of the automatic focusing method according to an embodiment of the present invention;

FIG. 2 is a schematic diagram of the structure of interferometer used in realizing the automatic focusing method of the invention;

FIG. 3 is a diagram indicating the distribution of the focusing function values vs the focusing positions obtained by the automatic focusing method of the present invention.

FIG. 4 is a diagram indicating the distribution of the focusing function values vs the focusing positions obtained with less sample points by the automatic focusing method of the present invention;

FIG. 5 is a diagram indicating the curve of focusing function first order differentiation values vs the focusing positions obtained by subjecting the focusing function of the curve shown in FIG. 3 to first order differentiation;

FIG. 6 is a flowchart of the steps of the automatic focusing method for the wave packet interval search according to an embodiment of the present invention;

FIG. 7 is another flowchart of the steps of the automatic focusing method for the wave packet interval search according to an embodiment of the present invention; and

FIG. 8 is a diagram indicating the distribution of the focusing function values vs the focusing positions obtained by the automatic focusing method according to an embodiment of the invention.

### DETAILED DESCRIPTION OF THE PREFERRED EMBODIMENT

The purpose, construction, features, and functions of the present invention can be appreciated and understood more thoroughly through the following detailed description with reference to the attached drawings.

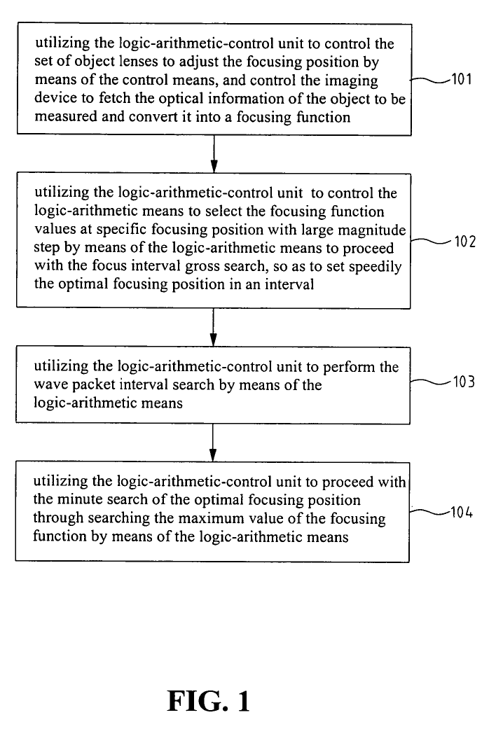

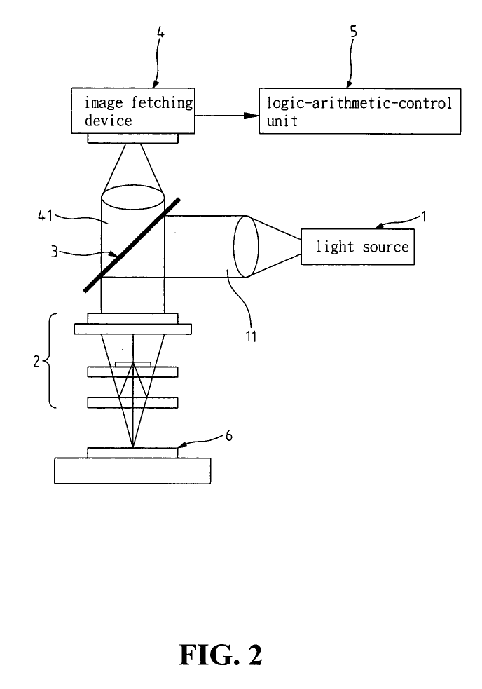

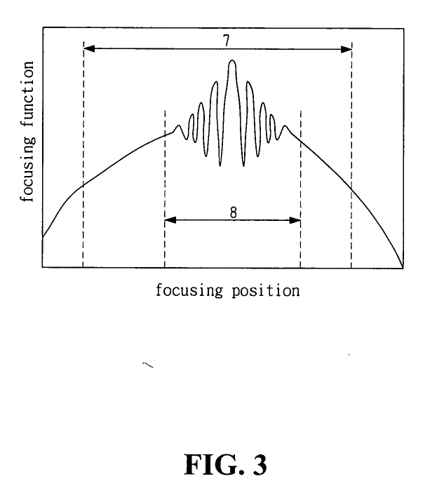

Firstly, referring to FIGS. 1 to 3. FIG. 1 is a flowchart of the steps of the automatic focusing method according to an embodiment of the present invention. FIG. 2 is a schematic diagram of the structure of interferometer used in realizing the automatic focusing method of the present invention. FIG. 3 is a diagram indicating the distribution of the focusing function values vs the focusing positions obtained by the automatic focusing method of the present invention. According to FIGS. 1 & 2, the present invention relates to an automatic focusing method for the image fetched by an optical image system. As shown in FIG. 2, the optical image system includes: a light source 1, a set of object lenses 2, a light splitter 3, an imaging device 4, and a logic-arithmetic-control unit 5. In the application of the automatic focusing method of the invention, an incident light beam 11 emitted from a light source 1 is reflected to a set of optical lenses 2 through a light splitter 3, and reaches the object 6 to be measured and then is reflected to form the reflected light beam 41 containing interference signals. This reflected light beam 41 passes through the set of object lenses 2 and is received by the imaging device 4 after penetrating through the light splitter 3. In the above-mentioned structure, the light source 1 generating the light signal of incident light beam 11 may be a white light source; the set of object lenses 2 is composed of the interference object lens and the related focal length adjustment means; and the logic-arithmetic-control unit 5 includes a logic-arithmetic means, a memory means and a control means, and may be composed of electronic circuit or computer system. Therefore, the logic-arithmetic-control unit 5 may perform the adjustment of the focus position of the set of object lenses and record the optical information obtained by the imaging device 4 through its control means and memory means respectively, so that the automatic focusing method of the present invention may be used to make calculation of the optical information obtained by the imaging device 4 to obtain the optimal focusing position by making use of the logic-arithmetic means of the logic-arithmetic-control unit 5. The automatic focusing method includes the following steps: utilizing the logic-arithmetic-control unit 5 to control the set of object lenses 2 to adjust the focusing position by means of the control means, and control the imaging device 4 to fetch the optical information of the object 6 to be measured and convert it into a focusing function, which contains the relations between the optical information and the focusing position (step 101); utilizing the logic-arithmetic-control unit 5 to control the logic-arithmetic means to select the focusing function values at specific focusing position with large magnitude step by means of the logic-arithmetic means to proceed with the focus interval 7 gross search, so as to set speedily the optimal focusing position in an interval, the focus interval 7 is such an interval specified by the focusing function values that it includes the focusing position to be adjusted as shown in FIG. 3 (step 102); utilizing the logic-arithmetic-control unit 5 to perform the wave packet interval search by means of the logic-arithmetic means, the wave packet interval 8 is such an interval specified by the focusing function values that it includes the interference image wave packet as shown in FIG. 3 (step 103); and utilizing the logic-arithmetic-control unit 5 to proceed with the minute search of the optimal focusing position through searching the maximum value of the focusing function by means of the logic-arithmetic means.

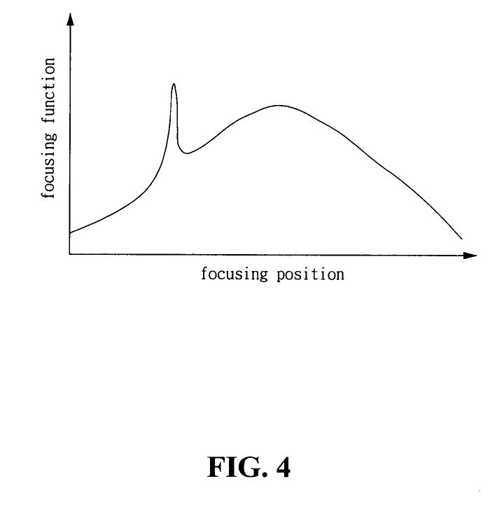

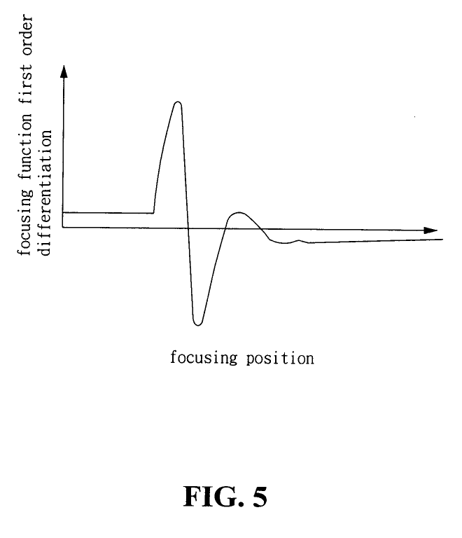

It is worthy to note that, in the above-mentioned steps, the steps of larger magnitude are utilized to select the focusing point value at the specific focusing position in a search interval. In this manner, less sample points are provided to the logic-arithmetic-control unit 5 for executing the logic operation required, thus obtaining the distribution of the focusing function values vs the focusing positions as shown in FIG. 4. Then, the curve of the distribution of FIG. 4 is subjected to a first order differentiation to obtain its tangent or slope value vs the focusing positions as shown in FIG. 5. As such the focusing position corresponding to the maximum value of slope thus acquired is the optimal focusing position obtained in the optimal focusing position gross search.

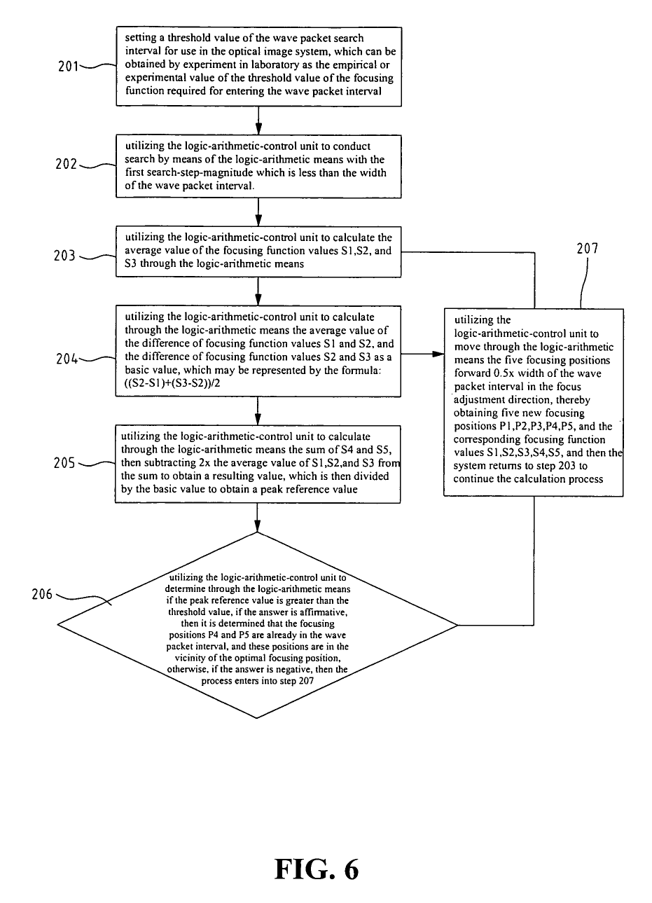

Next, referring to FIG. 6 for a flowchart of the steps of the automatic focusing method used for the wave packet interval search according to an embodiment of the present invention. As shown in FIG. 6, the wave packet interval search of the automatic focusing method includes the following steps: setting a threshold value of the wave packet search interval for use in the optical image system, which can be obtained by experiment in laboratory as the empirical or experimental value of the threshold value of the focusing function required for entering the wave packet interval (step 201); utilizing the logic-arithmetic-control unit 5 to conduct search by means of the logic-arithmetic means with the first search-step-magnitude which is less than the width of the wave packet interval. In the embodiment of the invention, the 0.5× the width of wave packet interval is used as the search-step-magnitude, thus obtaining the five focusing positions P1, P2, P3, P4 and P5 and the corresponding focusing function values S1, S2, S3, S4, and S5 (step 202); utilizing the logic-arithmetic-control unit 5 to calculate the average value of the focusing function values S1, S2, and S3 through the logic-arithmetic means (step 203); utilizing the logic-arithmetic-control unit 5 to calculate through the logic-arithmetic means the average value of the difference of focusing function values S1 and S2, and the difference of focusing function values S2 and S3 as a basic value, which may be represented by the formula: ((S2−S1)+(S3−S2))/2 (step 204); utilizing the logic-arithmetic-control unit 5 to calculate through the logic-arithmetic means the sum of S4 and S5, then subtracting 2× the average value of S1, S2, and S3 from the sum to obtain a resulting value, which is then divided by the basic value to obtain a peak reference value (step 205); utilizing the logic-arithmetic-control unit 5 to determine through the logic-arithmetic means if the peak reference value is greater than the threshold value, if the answer is affirmative, then it is determined that the focusing positions P4 and P5 are already in the wave packet interval, and these positions are in the vicinity of the optimal focusing position, otherwise, if the answer is negative, then the process enters into step 207 (step 206); and utilizing the logic-arithmetic-control unit 5 to move through the logic-arithmetic means the five focusing positions forward 0.5× width of the wave packet interval in the focus adjustment direction, thereby obtaining five new focusing positions P1, P2, P3, P4, P5, and the corresponding focusing function values S1, S2, S3, S4, S5, and then the system returns to step 203 to continue the calculation process.

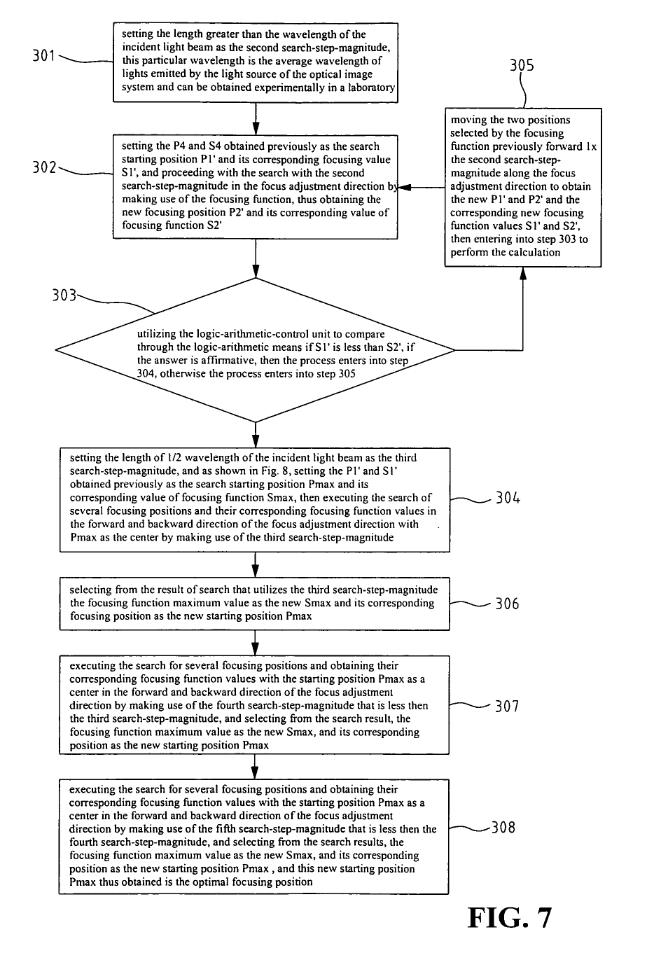

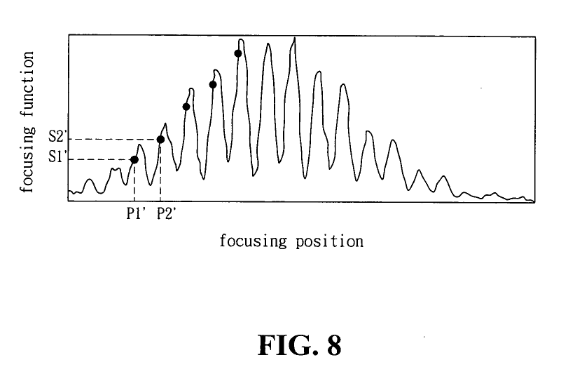

Then, referring to FIGS. 7 & 8. FIG. 7 is a flowchart of the steps of the automatic focusing method used for the wave packet interval search according to an embodiment of the present invention. FIG. 8 is a diagram indicating the distribution of the focusing function values vs the focusing positions obtained by the automatic focusing method according to an embodiment of the invention. As shown in FIG. 7, upon finishing the step of wave packet interval search, the automatic focusing method of the present invention is used to perform the minute search of the optimal focusing position, including the following steps: setting the length greater than the wavelength of the incident light beam as the second search-step-magnitude, this particular wavelength is the average wavelength of lights emitted by the light source of the optical image system and can be obtained experimentally in a laboratory (step 301); setting the P4 and S4 obtained previously as the search starting position P1′ and its corresponding focusing value S1′, and proceeding with the search with the second search-step-magnitude in the focus adjustment direction by making use of the focusing function, thus obtaining the new focusing position P2′ and its corresponding value of focusing function S2′ (step 302); utilizing the logic-arithmetic-control unit 5 to compare through the logic-arithmetic means if S1′ is less than S2′, if the answer is affirmative, then the process enters into step 304, otherwise the process enters into step 305 (step 303); setting the length of ½ wavelength of the incident light beam as the third search-step-magnitude, and as shown in FIG. 8, setting the P1′ and S1′ obtained previously as the search starting position Pmax and its corresponding value of focusing function Smax, then executing the search of several focusing positions and their corresponding focusing function values in the forward and backward direction of the focus adjustment direction with Pmax as the center by making use of the third search-step-magnitude (step 304); moving the two positions selected by the focusing function previously forward 1× the second search-step-magnitude along the focus adjustment direction to obtain the new P1′ and P2′ and the corresponding new focusing function values S1′ and S2′, then entering into step 303 to perform the calculation (step 305); selecting from the result of search that utilizes the third search-step-magnitude the focusing function maximum value as the new Smax and its corresponding focusing position as the new starting position Pmax (step 306); executing the search for several focusing positions and obtaining their corresponding focusing function values with the starting position Pmax as a center in the forward and backward direction of the focus adjustment direction by making use of the fourth search-step-magnitude that is less then the third search-step-magnitude, and selecting from the search result, the focusing function maximum value as the new Smax, and its corresponding position as the new starting position Pmax (step 307); executing the search for several focusing positions and obtaining their corresponding focusing function values with the starting position Pmax as a center in the forward and backward direction of the focus adjustment direction by making use of the fifth search-step-magnitude that is less then the fourth search-step-magnitude, and selecting from the search results, the focusing function maximum value as the new Smax, and its corresponding position as the new starting position Pmax , and this new starting position Pmax thus obtained is the optimal focusing position (step 308).

In the above-mentioned steps, the wave packets in the wave packet area of the fetched image information is an optical interference wave, so that the period of the wave packet spatial propagation corresponds to that of ½ the wavelength of the light emitted by the light source. As such, when the wavelength of the incident light is selected as the second search-step-magnitude, the size of the second search-step-magnitude is based on the wavelength of the incident light, however, if the magnitude of the search step is overly large, then the search may not produce any meaningful results. In addition, since the curve of the focusing function for the fetched image information in the wave packet interval is superimposed by the single-peak curve portion, so that the closer to the optimal focusing position the greater the focusing function value of the wave packet (to the phase of the same period). Therefore, in the afore-mentioned steps, the various search-step-magnitudes utilized are the integer times that of the ½ wavelength of the light emitted by the light source, the main reason for doing so is that with such search-step-magnitudes, once the search reaches the wave packet interval, it will find the same phase of the wave packets of various period distributions. Then the increase of the focusing function value can be used to determine that the search is getting close to the optimal focusing position.

Furthermore, in the above-mentioned steps, the millimeter-order search-step-magnitude is utilized to conduct the optimal focusing position search in step 307, while in step 308 the nanometer-order search-step-magnitude is utilized to conduct the optimal focusing position search. Thus, more accurate optimal focusing position can be obtained through diminishing search-step-magnitude.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements that are within the scope of the appended claims.

What is claimed is:

1. An automatic focusing method, comprising the following steps:
providing an optical image system including: a light source, a set of objective lenses, an imaging device, and a logic-arithmetic-control unit, said set of objective lenses includes the interference objective lenses and the focal length adjustment means, said logic-arithmetic-control unit includes control means and memory means, which are used to adjust the focal length of said set of objective lens and record the optical information acquired by the imaging device respectively, and said logic-arithmetic-control unit includes logic-arithmetic means, which is used to calculate the optical information acquired by the imaging device;
adjusting the focal length of said set of objective lenses, and controlling said imaging device to acquire the optical information of the object to be measured and convert it into a focusing function;
selecting the specific focusing position with large step magnitude by making use of the focusing function, and proceeding with the gross search in the focusing position interval;
performing the search in the wave packet interval; and
performing the minute search of the optimal focusing position;
wherein, the step of performing the minute search of the optimal focusing position includes further steps of;
searching for the maximum value of the focusing function in the wave packet interval by setting the integer times of ½ wavelength of the incident light as the search-step-magnitude, and defining the focusing position corresponding to the maximum value of the focusing function as the optimal focusing position.

2. The automatic focusing method as claimed in claim 1, wherein the step of optimal focusing position minute search includes further the following steps:
searching for the maximum value of the focusing function in the wave packet interval by setting the integer times of ½ wavelength of the incident light that is greater or equal to a wavelength as the first search-step-magnitude, and defining the focusing position corresponding to the maximum value of the focusing function as the first reference position; and
setting the ½ wavelength of the incident light as the second search-step-magnitude, and searching for the maximum value of the focusing function in the wave packet interval having the length of several ½ wavelengths of the incident light with the first reference position as the center, and defining the focusing position corresponding to the maximum value of the focusing function as the optimal focusing position.

3. The automatic focusing method as claimed in claim 1, wherein the step of optimal focusing position minute search includes further the following steps:
searching for the maximum value of the focusing function in the wave packet interval by setting the integer times of ½ wavelength of the incident light that is greater or equal to a wavelength as the first search-step-magnitude, and defining the focusing position corresponding to the maximum value of the focusing function as the first reference position;
setting the ½ wavelength of the incident light as the second search-step-magnitude, and searching for the maximum value of the focusing function in the wave packet interval having the length of several ½ wavelengths of the incident light with the first reference position as the center, and defining the focusing position corresponding to the maximum value of the focusing function as the second reference position; and
setting a millimeter order distance as the third search-step-magnitude, searching for the maximum value of the focusing function in the wave packet interval having a range of several millimeters with the second reference position as the center, and defining the focusing position corresponding to the maximum value of the focusing function as the optimal focusing position.

4. The automatic focusing method as claimed in claim 1, further comprising the following steps:
searching for the maximum value of the focusing function in the wave packet interval by setting the integer times of ½ wavelength of the incident light that is greater or equal to a wavelength as the first search-step-magnitude, and defining the focusing position corresponding to the maximum value of the focusing function as the first reference position;
setting the ½ wavelength of the incident light as the second search-step-magnitude, and searching for the maximum value of the focusing function in the wave packet interval having the length of several ½ wavelengths of the incident light with the first reference position as the center, and defining the focusing position corresponding to the maximum value of the focusing function as the second reference position;
setting the millimeter order distance as the third search-step-magnitude, searching for the maximum value of the focusing function in the wave packet interval having a range of several millimeters with the second reference position as the center, and defining the focusing position corresponding to the maximum value of the focusing function as the third reference position; and
setting the nanometer order distance as the fourth search-step-magnitude, searching for the maximum value of the focusing function in the wave packet interval having a range of several nanometers with the third reference position as the center, and defining the focusing position corresponding to the maximum value of the focusing function as the optimal focusing position.

5. The automatic focusing method as claimed in claim 1, wherein the step of wave packet interval search includes further the following steps:
setting a focusing function threshold value, thus selecting the focusing position close to the wave packet interval;
selecting the search-step-magnitude that is less than the width of wave packet interval to proceed with the search, meanwhile obtaining the focusing positions P1, P2, P3, P4 and P5 and the corresponding focusing function values S1, S2, S3, S4 and S5;
calculating the average of the focusing function values S1, S2 and S3;
calculating the average of the difference of S1−S2 and the difference of S2−S3 as a basic value, and its calculation formula can be represented by ((S2−S1)+(S3−S2))/2;
subtracting the sum of S4 and S5 from two times the average of the three pervious focusing function values to produce a resulting value, then the resulting value is divided by the basic value to obtain a peak reference value;
determining that if the peak reference value is greater than the threshold value, then P4 and P5 is already in the wave packet interval, and their positions are in the vicinity of the optimal focusing position; and
determining that if the peak reference value is less than the threshold value, then P4 and P5 have not reached the wave packet interval, then the logic-arithmetic-control unit is used to move the five focusing positions selected by the focusing function one search-step-magnitude forward in the direction of the focal adjustment direction, thus obtaining the new five positions of P1, P2, P3, P4 and P5 and the corresponding new focusing function values S1, S2, S3, S4, S5, and then return to the previous step to continue the calculation.

6. The automatic focusing method as claimed in claim 5, wherein the search-step-magnitude is selected to be 0.5× the width of the wave packet interval.

7. The automatic focusing method as claimed in claim 1, wherein the step of optimal focusing position gross search comprises further the steps of: as the curve of distribution of the focusing function values vs the focusing positions is subjected to a first order differentiation to obtain its tangent or slope value, the focusing position corresponding to the maximum value of slope is the optimal focusing position obtained in the optimal focusing position gross search.
